(19) United States
(12) Patent Application Publication
(10) Pub. No.: US 2012/0173201 A1
(43) Pub. Date: Jul. 5, 2012

(54) SENSOR FOR MEASURING A MEASUREMENT VARIABLE AND METHOD FOR OPERATING A SENSOR

(75) Inventors: Oliver Bister, Alsdorf (DE); Matthias Gitzen, Aachen (DE); Luc Hamers, Aachen (DE); Goetz Langer, Roetgen (DE); Andreas Niewoehner, Aachen (DE); Diethelm Schueller, Aachen (DE); Thorsten Von Sydow, Aachen (DE)

(73) Assignee: SCHAEFFLER TECHNOLOGIES AG & CO. KG, Herzogenaurach (DE)

(21) Appl. No.: 13/394,615

(22) PCT Filed: Aug. 25, 2010
(86) PCT No.: PCT/EP2010/062392

§ 371 Date: Mar. 14, 2012

(30) Foreign Application Priority Data
Sep. 7, 2009 (DE) 10 2009 040 383.3

(51) Int. Cl. G06F 15/00

(52) U.S. Cl. 702/188

(57) ABSTRACT

A sensor for measuring at least one measurement variable, which has a configurable measurement variable sensor that converts the measurement variable into measurement data. An arrangement for operating a sensor, which has a configurable measurement variable sensor. A method for operating a sensor which has a configurable measurement variable sensor. The sensor can be a vibration sensor for measuring mechanical vibrations and has a configurable measurement variable sensor for converting the measurement variables into measurement data and a processor. The sensor has an interface with multiple functions. The interface is used initially for transferring coded measurement data so that the measurement data can be read from the sensor. The interface is also used in the transfer of configuration data for the configuration of the measurement variable sensor and for transferring a supply voltage for the electric supply of the sensor. The sensor can be fully operated by the individual interface.

### FIELD OF THE INVENTION

The present invention relates to a sensor for measuring at least one measurement variable, which sensor comprises a configurable measurement variable pick-up for converting the measurement variable into measurement data. The invention also relates to an arrangement for operating a sensor, which arrangement comprises a configurable measurement variable pick-up. The invention also shows a method for operating a sensor with a configurable measurement variable pick-up. The sensor according to the invention may be, for example, a vibration sensor for measuring mechanical vibrations.

DE 10 2007 042 678 A1 shows a measuring instrument having a vibration sensor circuit for detecting vibrations of a machine and for producing a dynamic signal on the basis of the measured vibrations. The measuring instrument also comprises an analog/digital converter and a processor for processing the digitized signal. The digitized data may be wirelessly transmitted to a control protocol network via a data transmission module.

DE 102 23 725 A1 shows a process control system having a data acquisition and distribution system. A data flow between data acquisition devices and the data acquisition and distribution system may be effected using any desired network, for example a LAN or the Internet. Data can be acquired, for example, using web services.

DE 10 2006 002 887 A1 discloses an electrically adjustable item of furniture which has a control device having a data interface for connection to a data switching apparatus. Control data for maintaining the electrically adjustable item of furniture can be transmitted to the control device via a communication network, in particular via a public communication network.

DE 10 2007 002 351 A1 shows an inventory management system for automatically monitoring and controlling filling levels or pressure states. Bidirectional communication between individual field devices and a central system is enabled in this inventory management system. This communication preferably takes place with the aid of a web client via the Internet.

DE 698 10 975 T2 discloses a sensor system in which a multiplicity of sensors are connected to a first communication bus. A main computer designed with a second communication bus is connected to the first communication bus via a bus converter apparatus. The sensors can be controlled via the first communication bus. A disadvantage of this solution is that the sensors can be controlled only with the aid of the main computer connected to the bus converter apparatus. Another disadvantage is that special software for controlling the sensors must be installed on the main computer. The outlay for the plurality of communication buses and the bus converter apparatus is also disadvantageous.

On the basis of the prior art, the object of the present invention is to facilitate the operation of sensors, in particular the configuration of the sensors.

Said object is achieved by means of a sensor for measuring a measurement variable according to the appended claim 1. The object is also achieved by means of an arrangement for operating a sensor according to the appended coordinate claim 11. The inventive solution also provides a method for operating a sensor according to the appended coordinate claim 13.

The sensor according to the invention is used to measure at least one measurement variable, for example a physical or chemical property, such as temperature, speed, pressure, or else mechanical vibrations. The invention is not restricted to particular sensors but is suitable, in particular, for complex sensors having an embedded system, as is the case for many vibration sensors, for example. The sensor according to the invention comprises a configurable measurement variable pick-up for converting the measurement variable into measurement data. Parameters for recording a measurement variable, for example the measurement frequency and the quantization width, are defined when configuring the measurement variable pickup. Configuration may also comprise steps for starting up the measurement variable pick-up. The sensor also comprises a processor which is used, inter alia, to code the measurement data in order to be able to forward the latter. The processor is preferably also used to process the measurement data. According to the invention, the sensor has an interface having a plurality of functions. The interface is first of all used to transmit the coded measurement data so that the measurement data can be read from the sensor. The interface is also used to transmit configuration data for configuring the measurement variable pick-up. In the simplest case, the configuration data are unidirectionally transmitted to the sensor via its interface. The interface is also used to transmit a supply voltage for electrically supplying the sensor. This sensor can thus be completely operated via this single interface, as a result of which it can be installed with little outlay. There is no need for any separate connections for supplying the sensor and for transmitting data. In addition, the configuration data for configuring the measurement variable pick-up need not be transmitted via a special interface.

The processor is preferably configured to code the measurement data according to the Internet protocol, with the result that the measurement data can be transported via many available media. The measurement data may be fed into local and/or global networks, such as the Internet, and may be received at virtually any desired number of locations.

The interface of the sensor according to the invention is preferably designed for connection to a coaxial cable or to a cable with twisted conductor pairs. Coaxial cables and cables with twisted conductor pairs are often used in data networks and allow high data transmission rates and safe transmission of the supply voltage. For example, Ethernet networks in which power is supplied via the twisted conductor pairs according to the IEEE 802.3af standard (power over Ethernet) are particularly suitable. For this purpose, the sensor according to the invention has, for example, a standardized modular connection via which the sensor can be connected to a corresponding network connection with little outlay.

The sensor according to the invention can be particularly advantageously operated on the Internet. A remote station which interchanges sensor measurement data and configuration data can be arranged anywhere in the world and in a variable manner. There is no need to directly connect this remote station to the sensor. This considerably facilitates the configuration of the sensor, for example during maintenance, since this maintenance need not be carried out in situ. In addition, the field of application of the sensor is considerably extended since the measurement data of the sensor can be transmitted to any desired locations. For this purpose, the processor is configured to code the measurement data according to TCP/IP.

The processor of the sensor according to the invention is preferably configured to implement one or more web services and/or a web interface for configuring the measurement variable pick-up. In the case of a web service, XML-coded messages are interchanged via Internet-based protocols. In this embodiment of the sensor according to the invention, XML messages are agreed which comprise the necessary parameters for configuring the measurement variable pick-up. Consequently, a remote station which is connected to the interface of the sensor via the Internet, for example, can configure the measurement variable pick-up by transmitting XML messages. No proprietary software programs are needed on the remote station for this purpose. The XML messages can be bidirectionally interchanged between the sensor according to the invention and the remote station; for example, the sensor can confirm the configuration carried out with respect to the remote station. Alternatively or additionally, the processor of the sensor according to the invention may be configured to implement a web interface. The web interface makes it possible to interchange data according to the hypertext transfer protocol (HTTP). This makes it possible to communicate with a wide variety of remote stations. For example, the web interface may be controlled using a conventional PC on which a web browser is installed. Consequently, a sensor according to the invention which is connected to the Internet can be configured from any desired PC connected to the Internet without special preparations. In contrast to solutions according to the prior art, start-up and configuration in situ are not required.

The one or more web services and/or the web interface preferably has/have an authentication mechanism with a password request so that the sensor can be configured only by authorized persons.

The one or more web services and/or the web interface can also be configured to transmit the measurement data and/or status data of the measurement variable pick-up. Consequently, the measurement data and/or status data of the measurement variable pick-up can also be read with little effort from any desired PC connected to the Internet. This is advantageous, in particular, if measurement data and/or status data of the measurement variable pick-up are already required for configuration. In alternative embodiments of the sensor according to the invention, the status data of the measurement variable pick-up can also be transmitted in another manner via the interface.

In another preferred embodiment of the sensor according to the invention, the processor is configured to implement an e-mail service for transmitting measurement data, status data and/or configuration data of the measurement variable pick-up. As a result, measurement data, status data and/or configuration data of the measurement variable pick-up can also be transmitted to a person entrusted with operating the sensor when this person is currently not carrying out any maintenance on the sensor but can be reached by e-mail. This makes it possible to transmit, for example, warning messages or event messages relating to the presence of new measurement data to the person by e-mail, as a result of which the person gains knowledge thereof in real time. The person can also transmit e-mails to the sensor in order to configure the latter or to cause the sensor to carry out a particular action. For example, the sensor may be requested by e-mail to report its current state by e-mail.

In one preferred embodiment of the sensor according to the invention, the processor is configured to implement a configuration wizard for interactively configuring the measurement variable pick-up. The configuration wizard makes it possible to gradually configure the measurement variable pick-up by providing form fields, help texts or the like which make it possible for the person carrying out maintenance to configure the measurement variable pick-up. This person does not need to have any knowledge of the processing of the configuration data which is carried out in the sensor. The configuration wizard is preferably configured for use via the web interface and/or the web service, with the result that the configuration wizard can be called up, for example, in the web browser on any desired PC connected to the Internet.

The arrangement according to the invention for operating a sensor first of all comprises at least one sensor according to the invention. The arrangement according to the invention also comprises a data processing system which acts as a remote station and is intended to configure the sensor. The data processing system has a processor for processing data and has an interface for transmitting data to the sensor, preferably according to the Internet protocol. The data processing system may be formed, for example, by a conventional PC or a notebook. The data processing system and the sensor of the arrangement according to the invention can be connected to one another via their interfaces, for example via a local data network or preferably via the Internet.

The processor in the data processing system of the arrangement according to the invention is preferably configured to implement a web browser, an e-mail client and/or a configuration program for the sensor. The web browser mikes it possible to interchange measurement data, configuration data and/or status data with the sensor if the processor of the sensor is configured to implement a web interface. The e-mail client of the data processing system makes it possible to communicate with the sensor via e-mail if the processor of the sensor is configured to implement an e-mail service. If the sensor has a proprietary solution for configuring the measurement variable pick-up, the corresponding configuration program is required in the data processing system in order to configure the sensor.

The method according to the invention is used to operate a sensor with a configurable measurement variable pick-up for measuring a measurement variable. One step of the method according to the invention provides for the transmission of a supply voltage for electrically supplying the sensor via an interface of the sensor. This may be a permanent or a temporally interrupted supply of the sensor. Furthermore, configuration data for configuring the measurement variable pick-up are transmitted to the configurable measurement variable pick-up via the interface of the sensor. Depending on the operating mode of the sensor, the configuration data may be transmitted before operation for the first time, at particular intervals of time or permanently via the interface of the sensor. This may be unidirectional or bidirectional data transmission. Measurement data of the measurement variable pick-up which are preferably coded according to the Internet protocol are transmitted via the interface of the sensor. The transmission of the supply voltage, the transmission of the configuration data and the transmission of the measurement data are carried out using the same interface. This enables efficient operation of the sensor, in particular when the latter is being started up and configured or maintained.

In one preferred embodiment of the method according to the invention, the configuration data for configuring the measurement variable pick-up are transmitted via a web service and/or a web interface. As a result, the method according to the invention can be carried out on numerous available platforms, in particular on PCs connected to the Internet.

In another preferred embodiment of the method according to the invention, status data and/or the measurement data of the measurement variable pick-up are transmitted in the form of an e-mail via the interface. The e-mails transmitted via the Internet can be received throughout the world within a few seconds. This facilitates the monitoring of the operation of the sensor.

Further advantages, details and developments of the present invention emerge from the following description of a preferred embodiment, with reference to the drawing.

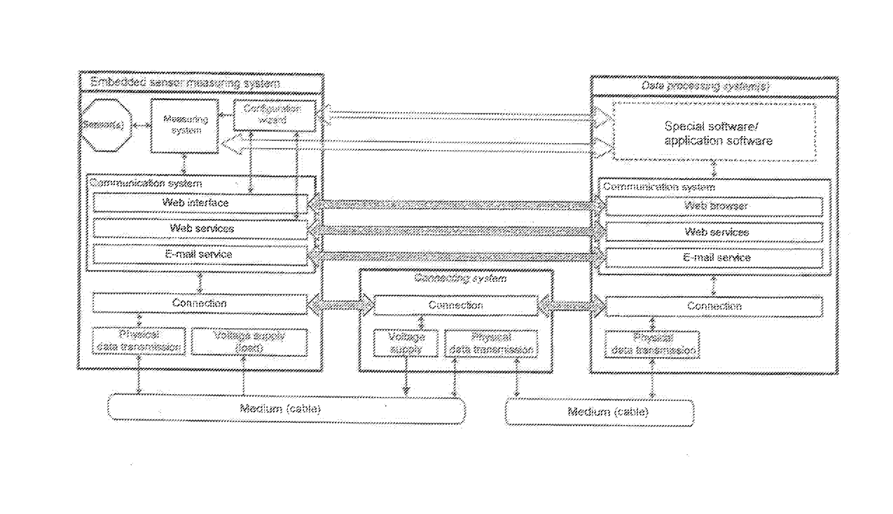

The single FIG. 1 shows a structural diagram of a preferred embodiment of an arrangement according to the invention for operating a sensor. The arrangement according to the invention first of all comprises an embedded sensor measuring system, for example a vibration sensor having an embedded microcontroller. The arrangement also comprises one or more data processing systems, for example PCs, notebooks or a special plant computer. The embedded sensor measuring system and the data processing systems are connected to one another via a connecting system. The connecting system ensures, on the one hand, a data connection between the embedded sensor measuring system and the data processing systems. The connecting system also comprises a voltage supply for the embedded sensor measuring system. For example, the embedded sensor measuring system may be connected to a LAN which is connected to the Internet. An Ethernet which supports the transmission of a voltage supply according to the power-over-Ethernet method is suitable for this purpose, for example. The one or more data processing systems are connected, for example, to the same LAN or to any desired Internet connection. The one or more data processing systems need not be supplied by the voltage supply of the connecting system since they generally have their own voltage supply when in the form of a PC or a notebook. An interface of the embedded sensor measuring system ensures the physical data transmission and the transmission of the supply voltage to the components of the embedded sensor measuring system in order to supply said components with an electrical voltage. In addition to the data transmission, a communication system and a configuration wizard are implemented by means of a processor in the embedded sensor measuring system. The processor is connected, via a measuring system, to one or more sensors each representing a configurable measurement variable pick-up. The communication system of the embedded sensor measuring system comprises a web interface, a web service and an e-mail service. Depending on the application, one or more of these components may also be dispensed with. A configuration wizard implemented in the embedded sensor measuring system makes it possible to interactively configure the measuring system and the sensors.

Configuration data, measurement data and/or status data can be interchanged between the embedded sensor measuring system and the one or more data processing systems via different programs or services in the data processing system. In one simple embodiment, proprietary application software is installed on the data processing system and is used to address the measuring system of the embedded sensor measuring system directly via the medium and the processor of the embedded sensor measuring system. The web interface of the embedded sensor measuring system can be addressed with the aid of a web browser which is present on a very large number of data processing systems. In any case, an e-mail service is usually present and can be used to interchange e-mails between the embedded sensor measuring system and the data processing system. If a program which is suitable for implementing the web service is installed on the data processing system, data can be interchanged with the data processing system via the web service of the embedded sensor measuring system. Web services are suitable, for example, for automated data transmission.

1-15. (canceled)

16. A sensor for measuring at least one measurement variable, comprising:
a configurable measurement variable pick-up for converting the measurement variable into measurement data;
a processor for coding the measurement data; and
an interface for transmitting the measurement data coded, for transmitting configuration data for configuring the measurement variable pick-up and for transmitting a supply voltage for supplying the sensor.

17. The sensor as claimed in claim 16, wherein the processor is configured to code the measurement data according to the Internet protocol.

18. The sensor as claimed in claim 16, wherein the interface is configured to be connectable to a coaxial cable or to a cable with twisted conductor pairs.

19. The sensor as claimed in claim 18, wherein the interface is designed according to IEEE 802.3af standard.

20. The sensor as claimed in claim 16, wherein the processor is configured to code the measurement data according to TCP/IP.

21. The sensor as claimed in claim 16, wherein the processor is configured to implement at least one web service and/or a web interface for configuring the measurement variable pick-up.

22. The sensor as claimed in claim 16, wherein the processor is configured to transmit status data of the measurement variable pick-up via the interface.

23. The sensor as claimed in claim 22, wherein the processor is configured to implement an e-mail service for transmitting measurement data, status data and/or configuration data of the measurement variable pick-up.

24. The sensor as claimed in claim 16, wherein the processor is configured to implement a configuration wizard for interactively configuring the measurement variable pick-up.

25. The sensor as claimed in claim 16, wherein the measurement variable is formed by a distance, a speed, an acceleration or a mechanical vibration.

26. An arrangement for operating a sensor, comprising:
a sensor having a configurable measurement variable pick-up for converting the measurement variable into measurement data a processor for coding the measurement data, and an interface for transmitting the measurement data coded, for transmitting configuration data for configuring the measurement variable pick-up and for transmitting a supply voltage for supplying the sensor; and
a data processing system for configuring the sensor, the data processing system having a processor and an interface for transmitting data to the sensor.

27. The arrangement as claimed in claim 26, wherein the processor in the data processing system is configured to implement a web browser, an e-mail client and/or a configuration program for the sensor.

28. A method for operating a sensor with a configurable measurement variable pick-up for measuring a measurement variable, comprising the following steps:
transmitting a supply voltage for electrically supplying the sensor via an interface of the sensor;
transmitting configuration data for configuring the measurement variable pick-up via the interface of the sensor; and
transmitting measurement data of the measurement variable pick-up via the interface of the sensor.

29. The method as claimed in claim 28, including transmitting the configuration data for configuring the measurement variable pick-up via a web service and/or a web interface.

30. The method as claimed in claim 28, including transmitting status data and/or the measurement data of the measurement variable pick-up as an e-mail via the interface.
